(19) United States
(12) Patent Application Publication
(10) Pub. No.: US 2009/0081454 A1
(43) Pub. Date: Mar. 26, 2009

(54) Carbon Nanoparticles, Production and Use Thereof

(75) Inventors: Peter Axmann, Erbach (DE); Margret Wohlfahrt-Mehrens, Illertissen (DE); Ulrich Storr, Ulm (DE)

Correspondence Address: THE NATH LAW GROUP, 112 South West Street, Alexandria, VA, 22314, US

(73) Assignee: ZENTRUM FUR SONNENENERGI-UND WASSERSTOFF- FORSCHUNG BADEN WURTTEMBERG GEMEINNUTZIGE SHIFTUNG, STUTTGART (DE)

(21) Appl. No.: 11/922,753

(22) PCT Filed: Jul. 7, 2006
(86) PCT No.: PCT/EP2006/006680

§ 371 Date: May 23, 2008

(30) Foreign Application Priority Data
Jul. 8, 2005 (DE) 10-2005-032-072.4

(51) Int. Cl. D01F 9/12; C01B 31/00; B32B 9/00; B05D 1/00; B82B 1/00; B82B 3/00

(52) U.S. Cl. 428/367; 423/447.2; 423/445 R; 427/249.4; 977/742

(57) ABSTRACT

The invention relates to carbon nanoparticles from fibers or tubes or combinations thereof, which have the morphology of macroscopic, spherical and/or spheroid secondary agglomerates, separated from each other. The invention also relates to a method for producing carbon nanoparticles by a CVD method using nanoporous catalyst particles having a spherical and/or spheroid secondary structure and comprising nanoparticulate metals and/or metal oxides or the precursors thereof as the catalytically active components. The inventive carbon nanoparticles are suitable for use in adsorbents, additives or active materials in energy accumulating systems, in supercapacitors, as filtering media, as catalysts or supports for catalysts, as sensors or as substrate for sensors, as additives for polymers, ceramics, metals and metal alloys, glasses, textiles and composite materials.

### FIELD OF THE INVENTION

The present invention relates to carbon nanoparticles composed of fibers or tubes that are morphologically embodied in the form of spherical and/or spheroidal secondary agglomerates, a method for their manufacture, and their use.

### BACKGROUND OF THE INVENTION

Solid substances with nanoscopic particle sizes are referred to as so-called nanomaterials. In these materials, sudden changes in properties or even new product properties can occur in comparison to microscopic particle sizes. Nanomaterials are thought to have significant potential for technical applications. Compared to the wide variety of new nanoscopic material systems, though, only a few nanomaterials have become established on the market.

The reasons for this include the fact that in the overall production line, technical processes are optimized for macroscopic particles and either cannot be used for nanomaterials or can only be used to a limited degree. This problem extends from material syntheses, through the preparation, isolation, and stabilization of the individual particles, to fashioning them into technical semi-finished products or finished products.

There is also insufficient knowledge about the toxicological effects of nanoscopic materials so that additional safety steps must be taken to avoid emission of nanoparticles.

### PRIOR ART

To synthesize carbon nanoparticles in the form of tubes or fibers, also referred to as carbon nanotubes or carbon nanofibers, essentially three different techniques are used, namely arc discharging, laser ablation, and CVD (chemical vapor deposition).

In arc discharging, a carbon gas is generated between two carbon electrodes and carbon nanotubes are formed from this gas in the presence of a catalyst or also without a catalyst.

In laser ablation, a carbon target is vaporized by a laser in an Ar or He atmosphere. Upon cooling, the carbon units condense and form carbon nanomaterials.

Arc discharging and laser ablation can in fact be used to manufacture good quality nanotubes that are suitable to a limited degree for research applications, but are not suitable for industrial production.

The CVD method uses a carbon source that is gaseous under reaction conditions, e.g. methane, ethene, or CO, as well as a catalyst that usually contains active components from the range of transitional elements Fe, Co, and Ni. At suitable temperatures, carbon nanotubes are deposited on the catalyst particles. For example, it is known from Chemical Physics Letters 364 (2002), pp. 568-572 to manufacture carbon nanotubes by means of CVD in a fluidized-bed reactor. In this instance, the nanotubes are convoluted and accumulate in a loose powdered form.

Carbon, vol. 41 (2003), pp. 539-547 describes the manufacture of carbon nanotubes by means of a CVD process in which acetylene is used as a carbon source and an iron catalyst is used. Here, too, the carbon nanotubes form convolutions.

In none of the above-described CVD processes do the carbon nanoparticles accumulate morphologically in the form of secondary agglomerates that can be clearly distinguished from one another, but instead form agglomerate structures that cannot be clearly defined.

Although carbon is not toxic in and of itself, the safety aspect is also an essential factor with carbon nanotubes. On the one hand, it has not yet been possible to rule out a hazard potential of conventional carbon materials and on the other hand, finely distributed transitional metals such as Co or Ni are used to manufacture the materials, which are contained both in the catalyst and in the carbon nanotubes. It is therefore absolutely necessary with carbon nanoparticles to both suppress particle emissions as much as possible and to provide carbon nanoparticles that are improved with respect to their further processability.

### OBJECT OF THE INVENTION

The object of the present invention, therefore, is to provide carbon nanoparticles composed of fibers or tubes with which the emission of nanoscopic units including carbon nanoparticles and metal nanoparticles into the environment is reduced and that are improved with respect to their isolation and processing as well as reprocessability in technically advancing processes. The invention should also disclose a simple method for their manufacture.

### SUMMARY OF THE INVENTION

The above-mentioned object is attained by means of the carbon nanoparticles recited in claim 1 and by means of a method for their manufacture recited in claim 11.

Preferred and suitable embodiments of the subject of the application are disclosed in the dependent claims. Possible uses of the carbon nanoparticles according to the present invention are disclosed in claims 14-20.

The subject of the present invention consequently includes carbon nanoparticles composed of fibers, tubes, or combinations thereof, which are morphologically embodied in the form of macroscopic, spherical and/or spheroidal secondary agglomerates that are differentiated from one another.

Another subject of the present invention is a method for manufacturing carbon nanoparticles by means of a CVD process through the use of nanoporous catalyst particles with a spherical and/or spheroidal secondary structure, which contain, as catalytically active components, nanoparticulate metals and/or metal oxides or their precursors.

Lastly, another subject of the invention is the use of carbon nanoparticles, for example as adsorbents, additives, or active materials in energy storage systems, in super condensers, as filter media, as supports for catalysts, as sensors or substrates for sensors, or as additives for polymers, ceramics, metals, and metal alloys, glasses, textiles, and composite materials such as carbon composite materials.

### DETAILED DESCRIPTION OF THE INVENTION

The carbon nanoparticles according to the present invention differ from conventional carbon nanoparticles in that they are morphologically embodied in the form of macroscopic, spherical and/or spheroidal secondary agglomerates that are clearly differentiated from one another.

It has surprisingly turned out that according to the present invention, clearly differentiated secondary particles can be provided, which are composed of carbon nanofibers and/or carbon nanotubes. In this instance, it has been discovered that the form of the secondary agglomerates almost completely reproduces that of the particle form of the catalyst used according to the present invention; in comparison to the catalyst particles used, a volume increase is observed, which, depending on the reaction conditions, can exceed the initial structure by a factor of approximately 350.

Due to the clear definition of the secondary agglomerates and the possibility, through the selection of suitable catalyst morphologies, of producing specific forms of secondary agglomerates, the carbon nanoparticles according to the present invention are more usable and optimizable in comparison to the prior art with respect to their technical reprocessing.

The fibers or tubes of the carbon nanoparticles according to the present invention typically have a diameter of 1-500 nm, preferably 10-100 nm, and more preferably 10-50 nm.

The size of the secondary agglomerates can be controlled through the size of the catalyst particles, the composition of the catalyst, and the selection of synthesis parameters such as the carbon source, concentrations, temperatures, and reaction time. The form of the end product is predetermined by the catalyst morphology. Preferably, the secondary agglomerates according to the invention have a diameter of 500 nm to 1000 μm. In comparison to the particle size distribution of the catalyst, the relative particle size distribution in the end product is maintained in spite of the significant volume increase.

With regard to the mechanism for the growth of fibers or tubes, it is assumed that at higher temperatures, the carbon obtained from carbon sources dissolves in the catalytically active metal and can then be deposited again in a nanoscopic form. In many cases, the secondary agglomerates do not contain a core of the catalyst particle but are instead entirely composed of carbon nanomaterials that are convoluted into one another.

The carbon nanofibers according to the present invention can be of the herringbone type, the platelet type, and the screw type. The carbon nanotubes can be of the single-walled or multiple-walled type or of the loop type.

According to the present invention, it is preferable if the circumference Up of the nanoparticles in the two-dimensional projection and the circumference of a circle of the same area Uk are in a ratio of Uk:Up in the range from 1.0 to 0.65.

The carbon nanoparticles according to the invention are manufactured by means of a CVD process using nanoporous catalyst particles with a spherical and/or spheroidal secondary structure, which contain, as catalytically active components, nanoparticulate metals or their precursors. These catalyst particles can additionally contain metal oxides or their precursors that serve as a substrate for the actually catalytically active metals. In particular, Fe, Co, Ni, and Mn are suitable for the catalyst metal. It is possible to use both pure metals and metal oxides/metal composites, as well as their precursors. Poorly soluble compounds such as hydroxides, carbonates, or other compounds that can be transformed into catalytically active metals or metal/support composites can be used as the precursors.

As a carbon source, the carbon-containing compounds used according to prior art are used, which are in gaseous form at the respective reaction temperature, e.g. methane, ethene, acetylene, CO, ethanol, methanol, synthetic gas mixtures, and biogas mixtures.

The conditions for the CVD process are known to those skilled in the art and correspond to those of the prior art.

### PREFERRED EMBODIMENTS

The invention will be explained in greater detail in conjunction with the following examples and the accompanying drawings.

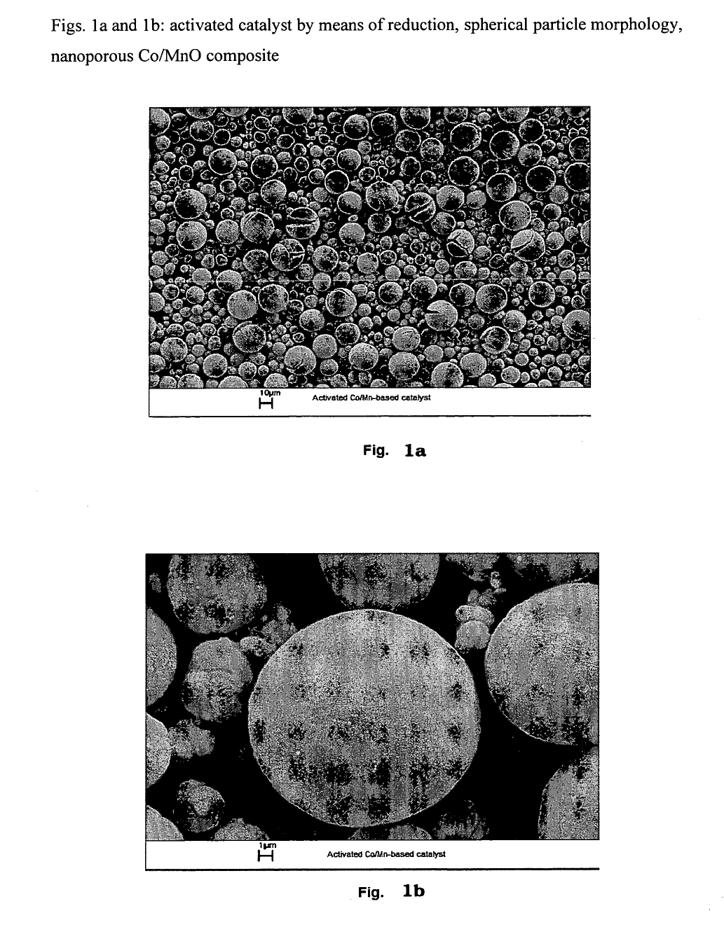

FIGS. 1a and 1b show REM images of the activated catalyst from example 1

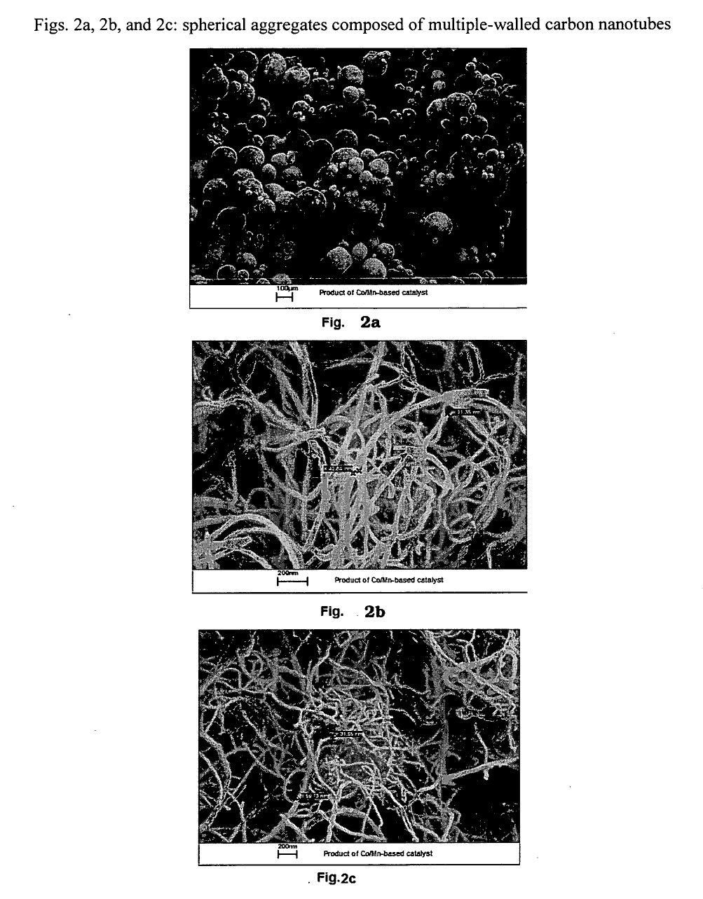

FIGS. 2a, 2b, and 2c show REM images of the product from example 1

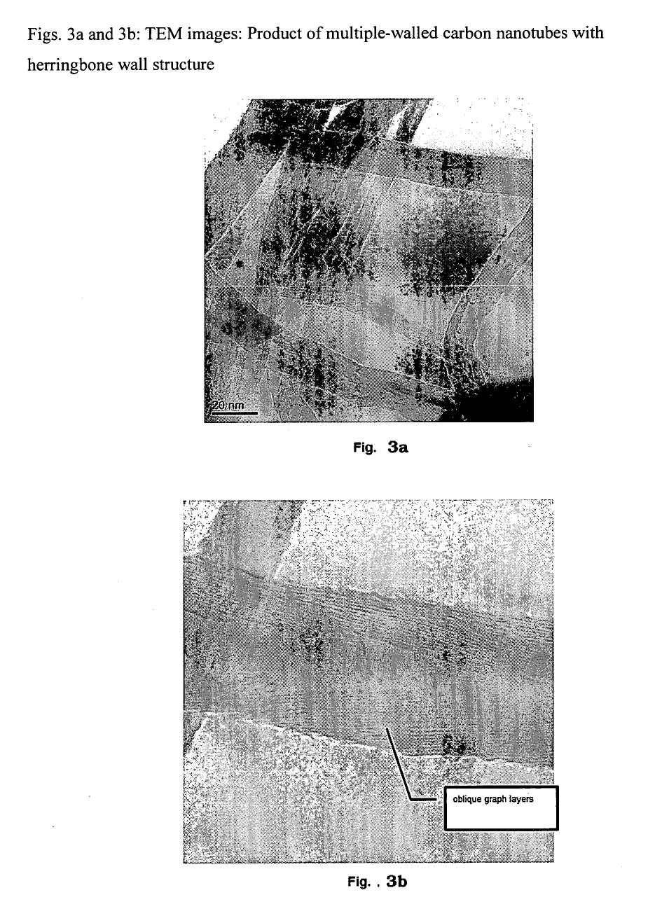

FIGS. 3a and 3b show TEM images of the product from example 1

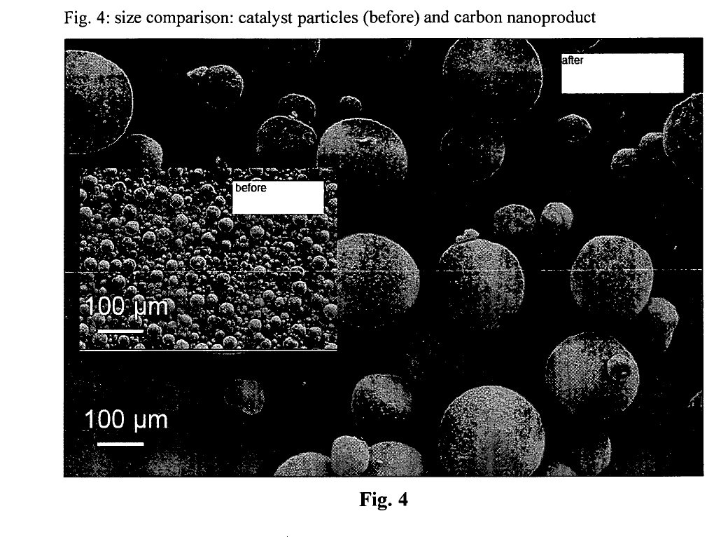

FIG. 4 shows a size comparison of the catalyst particles used and the product from example 1, based on REM images

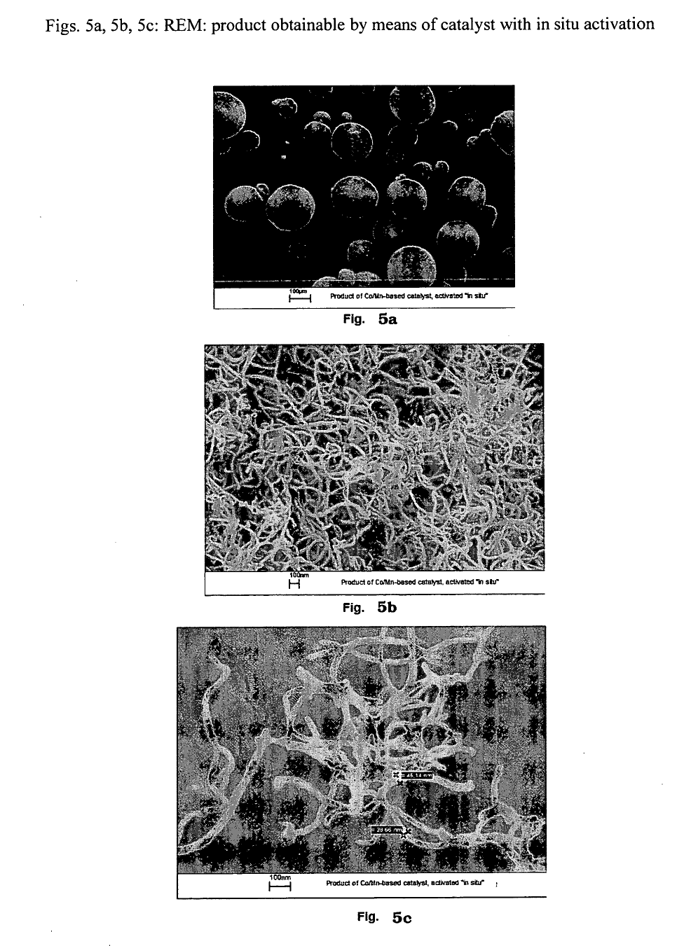

FIGS. 5a, 5b, and 5c show REM images of the product from example 2

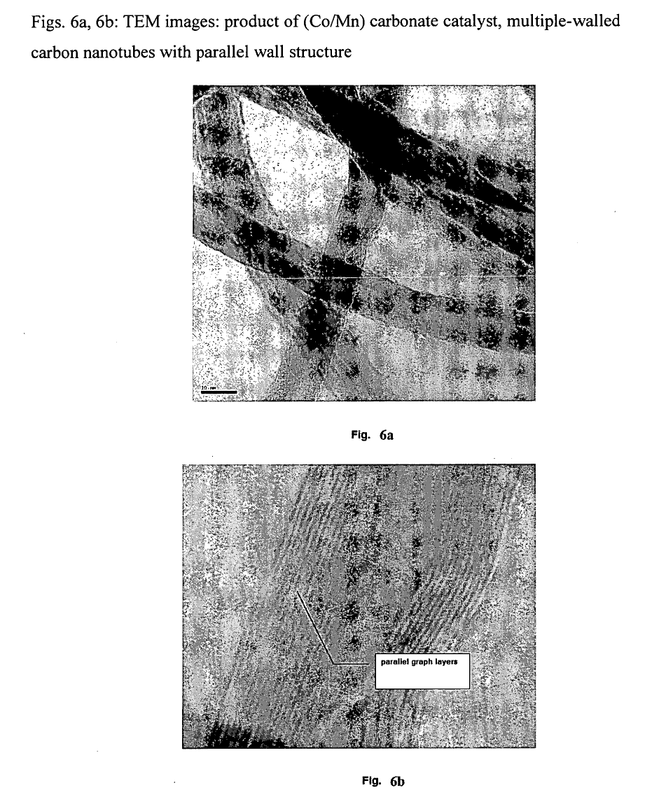

FIGS. 6a and 6b show TEM images of the product from example 2

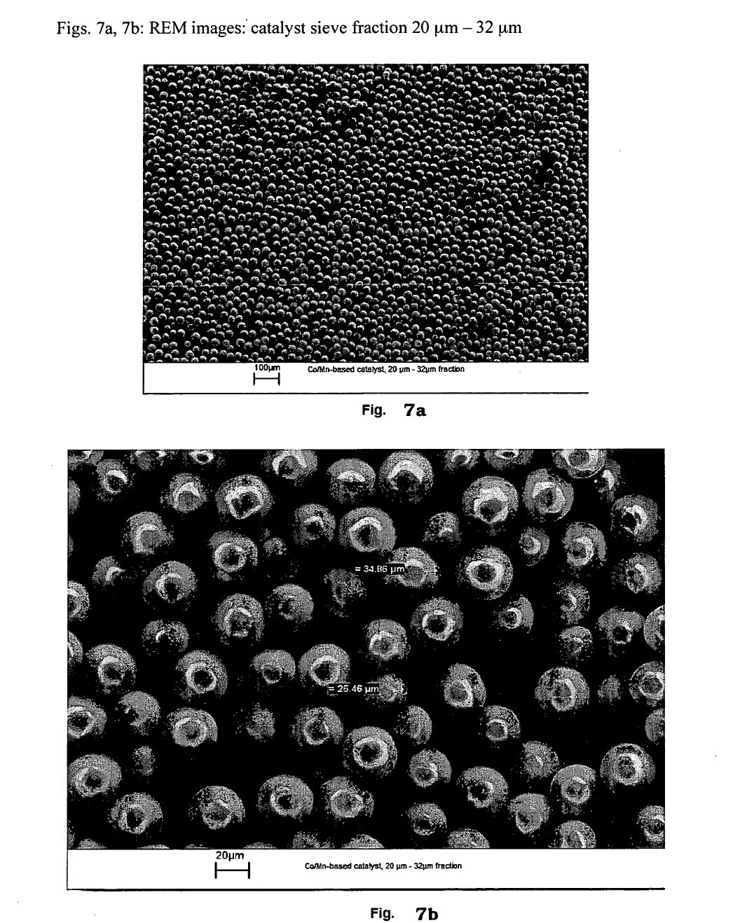

FIGS. 7a and 7b show REM images of the catalyst used in example 3

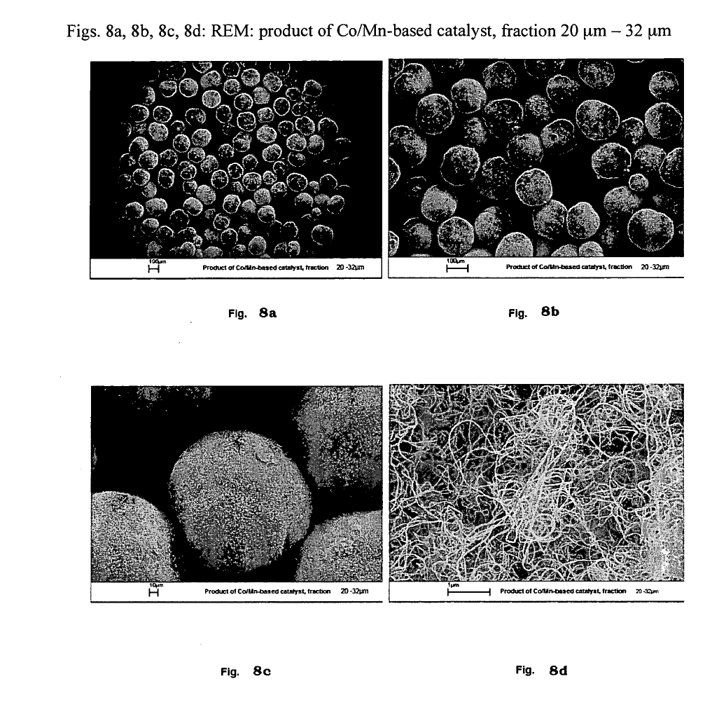

FIGS. 8a, 8b, 8c, and 8d show REM images of the product from example 3

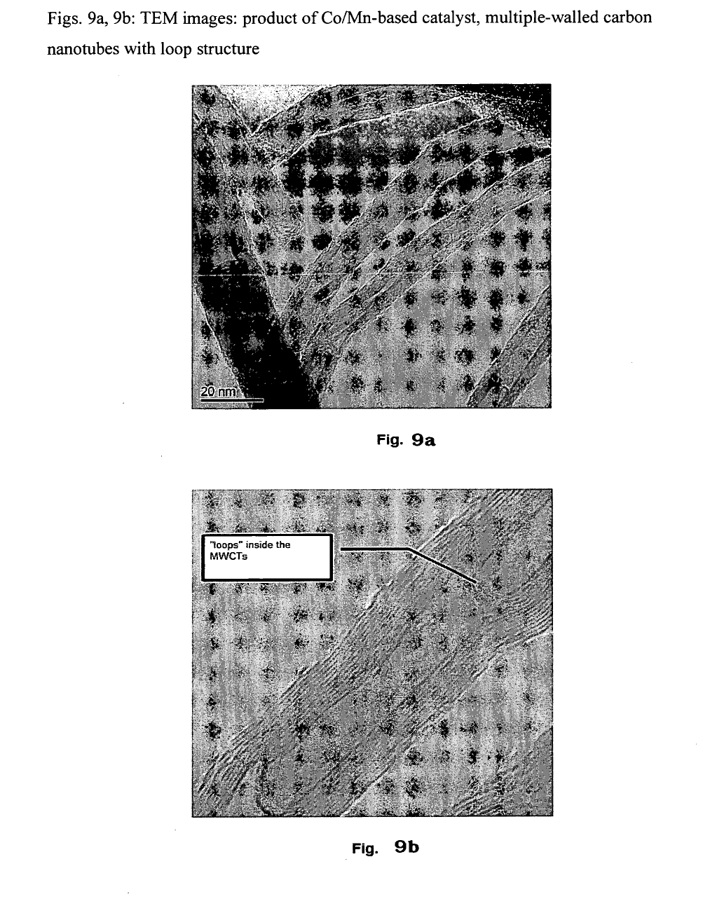

FIGS. 9a and 9b show TEM images of the product from example 3

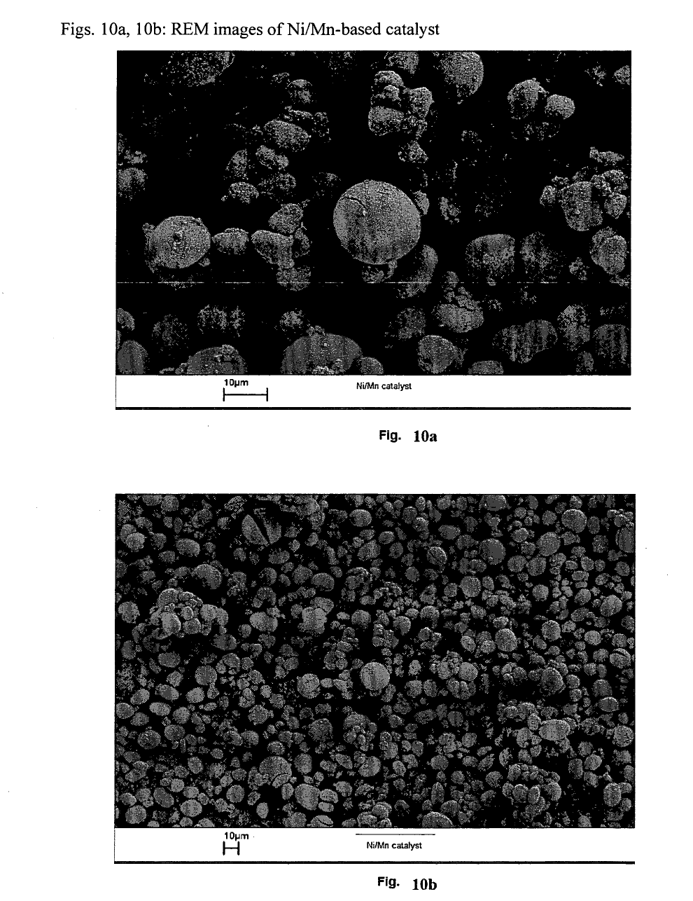

FIGS. 10a and 10b show REM images of the catalyst from example 4

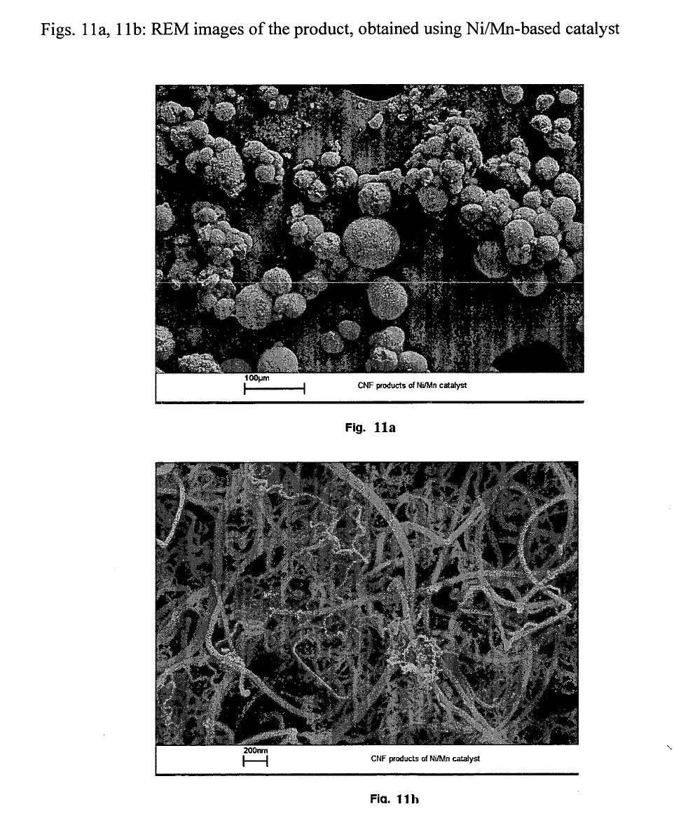

FIGS. 11a and 11b show REM images of the product from example 4

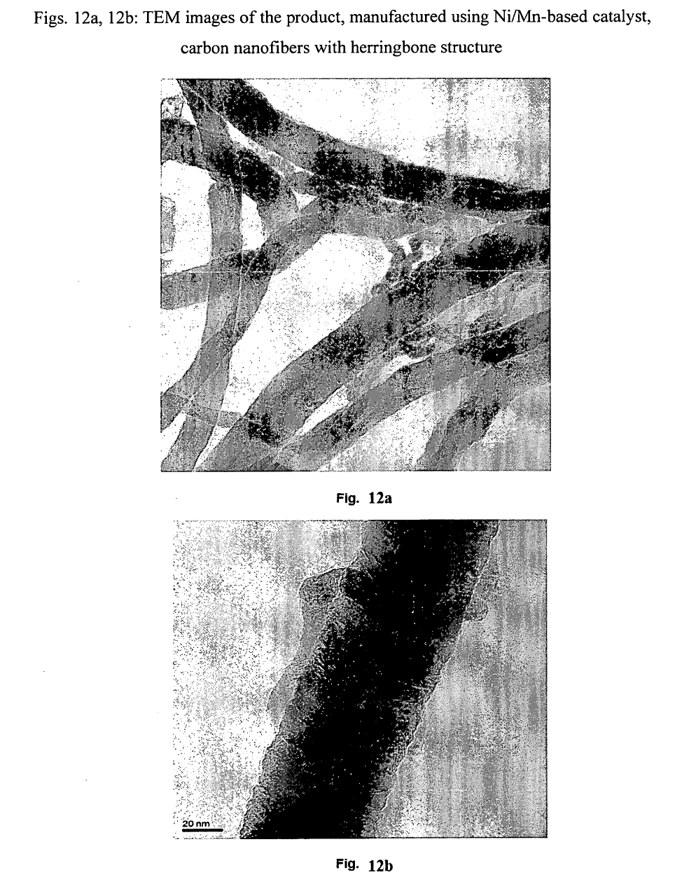

FIGS. 12a and 12b show TEM images of the product from example 4

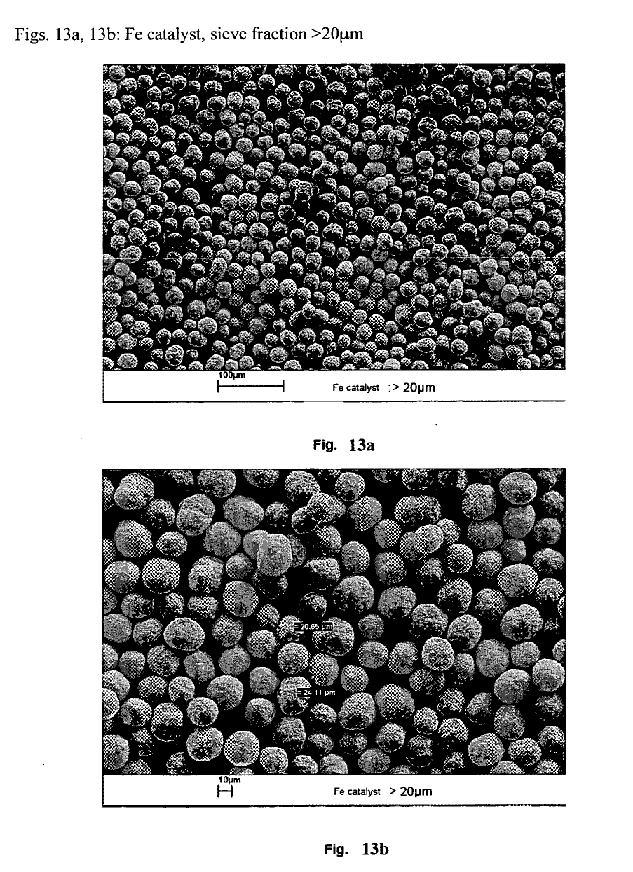

FIGS. 13a and 13b show REM images of the catalyst from example 5

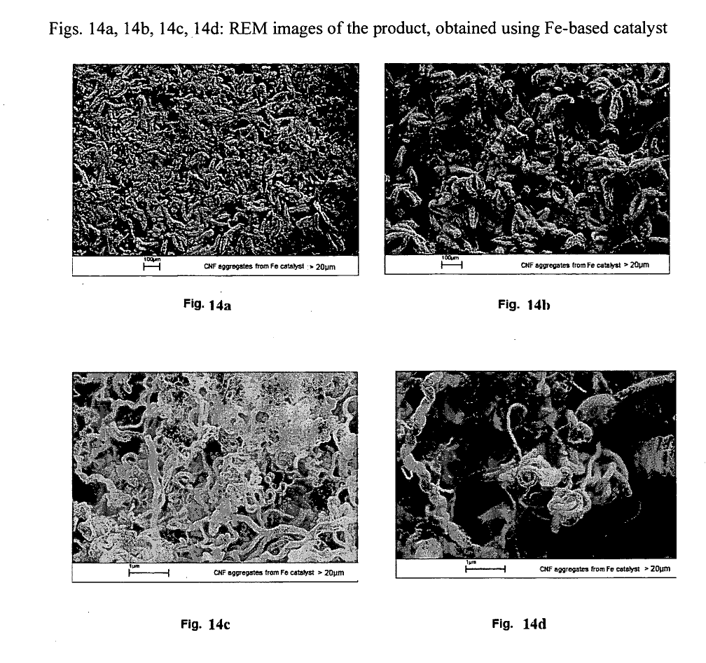

FIGS. 14a, 14b, 14c, and 14d show REM images of the product from example 5

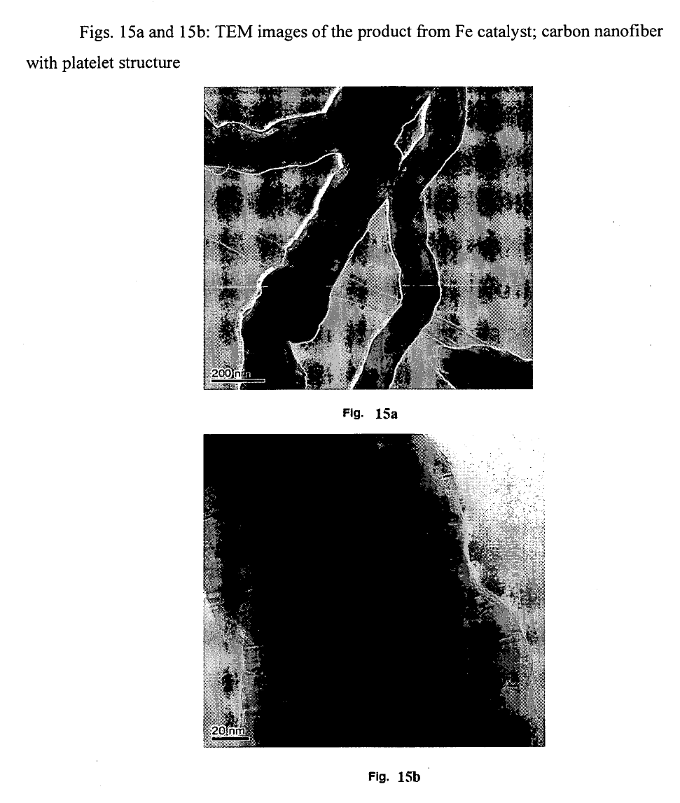

FIGS. 15a and 15b show TEM images of the product from example 5

### EXAMPLE 1

### Manufacture of Spherical Aggregates Composed of Multiple-Walled Carbon Nanotubes by Means of a Co/Mn-Based Catalyst

### Manufacture of the Catalyst

The catalyst is manufactured through continuous combining of three educt solutions.
Solution I:
3050 ml of a solution of 1172.28 g (NH₄)₂CO₃ (stoichiometric) in demineralized water
Solution II:
3130 ml of a solution of 960.4 g Co(NO₃)₂*6H₂O and 828.3 g Mn(NO₃)₂*4H₂O
Solution III:
960 ml of a 10.46 mole ammonia solution

The individual solutions are simultaneously metered into a 1-liter reactor at a constant metering speed over a period of 24 h; the reactor permits an intensive, thorough mixing and is equipped with an overflow via which product suspension is continuously discharged. The precipitation reaction occurs at 50° C. After the first 20 h, the discharging of the product via the overflow is begun. The suspension has a deep blue-violet color. The solid is separated from the mother liquor on a filter nutsch, then rinsed six times with 100 ml batches of demineralized water, and then dried for 30 h at 80° C. in a drying oven. This yields a powdered, easily flowing, violet precursor with spherical particle morphology.

### Activation of the Catalyst

In a corundum combustion boat, 2 g of the precursor is exposed to a forming gas flow of 5% H₂/95% N₂ for two hours at a temperature of 550° C. and transformed into a black powder that can be used as a catalyst. XRD spectra of the powder show the reflection patterns of metallic cobalt next to MnO. FIGS. 1a and 1b show REM images of the activated catalyst in the form of spherical particles.

### Manufacture of Carbon Nanoparticles

In a ceramic combustion boat, 0.2 g of the activated catalyst are placed into a tubular furnace. After a ten-minute 30 l/h flushing of the furnace with helium at a furnace temperature of 500-700° C., a mixture of ethene 10 l/h and helium 5 l/h are continuously conveyed over the specimen for a period of 5 h.

This yielded 11.2 g of a black, voluminous product.

REM images of the product are shown in FIGS. 2a, 2b, and 2c. The morphological embodiment as clearly differentiated spherical and/or spheroidal secondary structures is maintained. Highly magnified REM images show that the balls are composed entirely of fiber-shaped components (FIGS. 2b and 2c). TEM images (FIGS. 3a and 3b) verify the presence of multiple-walled carbon nanotubes.

FIG. 4 shows a size comparison between the catalyst particles used and the carbon nanoproduct obtained.

### EXAMPLE 2

### Manufacture of Multiple-Walled Carbon Nanotube Aggregates by Means of a (Co,Mn)CO₃ Catalyst

A catalyst according to example 1 is used without prior activation, directly for the manufacture of multiple-walled carbon nanotubes. As in example 1, the transformation into multiple-walled carbon nanotubes occurs without a prior reduction step. The product demonstrates a uniform distribution in the thickness of the nanotubes, as is clear from the REM images in FIGS. 5a, 5b, and 5c.

The TEM images in FIGS. 6a and 6b verify the presence of multiple-walled carbon nanotubes.

### EXAMPLE 3

### Manufacture of Multiple-Walled Carbon Nanotube Aggregates with Narrow Particle Distribution by Means of a (Co,Mn)CO₃ Catalyst

A catalyst according to example 1 is classed according to size by means of sieving and a particle size fraction of 20 μm-32 μm is used without prior activation, directly as a catalyst. FIGS. 7a and 7b show REM images of the catalyst sieve fraction used.

The transformation into multiple-walled carbon nanotubes takes place as in example 1.

This yields spherical aggregates composed of multiple-walled nanotubes with a narrow particle size distribution. With comparable transformation conditions, this makes it possible to adjust the size of the spherical carbon nanotube aggregates by means of the size of the catalyst particles. REM images of the product are shown at various magnifications in FIGS. 8a, 8b, 8c, and 8d.

The TEM images in FIGS. 9a and 9b confirm the presence of multiple-walled carbon nanotubes.

### EXAMPLE 4

### Manufacture of Spheroidal Carbon Nanofiber Units of the “Herringbone” Type by Means of a Ni/Mn-Based Catalyst

### Manufacture of the Catalyst

### Educt Solutions:

Solution I:
2400 ml of a solution of 1195.8 g Mn(NO₃)₂*4H₂O and
1385.4 g Ni(NO₃)₂*6H₂O in demineralized water
Solution II:
7220 ml of a solution of 1361.4 g Na₂CO₃ (waterless) in demineralized water

The synthesis takes place through the continuous combining of the individual solutions as described under example 1. The reaction temperature for this catalyst is 40° C. Product discharge begins after 20 h by means of the overflow. The solid is separated from the mother liquor on a filter nutsch, then rinsed six times with 100 ml batches of demineralized water, and then dried for 30 h at 80° C. in a drying oven under protective gas. The product is powdered and light brown in color. Its color darkens when stored in the presence of air.

FIGS. 10a and 10b show REM images of the catalyst.

### Activation of the Catalyst and Synthesis of the Carbon Nanofibers of the Herringbone Type

The activation of the catalyst occurs during heating between 300° C. and 600° C. through reduction of the precursor with H₂ for approx. 20 min. (gas mixture 24 l/h C₂H₄, 6 l/h H₂).

The synthesis occurs at 500-600° C. 2 h with a mixture of 32 l/h C₂H₄, 8 l/h H₂.

FIGS. 11a and 11b show REM images of the product. The morphological embodiment in the form of clearly differentiated spherical and/or spheroidal secondary structures is maintained.

The TEM images in FIGS. 12a and 12b confirm the presence of carbon nanofibers with a herringbone structure.

### EXAMPLE 5

### Manufacture of Flower-Like Carbon Nanofiber Units of the “Platelet” Type by Means of an Fe-Based Catalyst

### Manufacture of the Catalyst

Solution I:
3000 ml of a solution of 1084.28 g Fe(II) SO₄*7H₂O in demineralized water
Solution II:
6264 ml of a solution of 426.3 g (NH₄)₂CO₃ (stoichiometric) in demineralized water.

The synthesis takes place through the continuous combining of the individual solutions as described under example 1; the reaction temperature for this catalyst is 45° C. Product discharge begins after 20 h by means of the overflow. The solid is separated from the mother liquor on a filter nutsch, then rinsed six times with 100 ml batches of demineralized water, and then dried for 30 h at 80° C. in a drying oven. All steps are carried out under nitrogen. The product is powdered and light brown in color. Its color darkens when stored in the presence of air.

FIGS. 13a and 13b show REM images of the catalyst sieve fraction>20 μm.

### Activation of the Catalyst and Synthesis of Platelet Carbon Nanofibers

In a corundum combustion boat, 2 g of the precursor is activated in a helium/hydrogen mixture (2/3:1/3) for two hours at a temperature of 380° C.

The synthesis of the carbon nanofibers occurs under a carbon monoxide/hydrogen flow (20:8) for a period of four hours. This yields a black, voluminous product.

REM images of the product are shown at various magnifications in FIGS. 14a, 14b, 14c, and 14d. Clearly differentiated secondary agglomerates in the form of flower-like units are produced, whose outer circumference is spheroidal.

The TEM images in FIGS. 15a and 15b confirm the presence of carbon nanotubes of the platelet type.

1. Carbon nanoparticles composed of fibers, tubes, or combinations thereof, which are morphologically embodied in the form of macroscopic, spherical and/or spheroidal secondary agglomerates that are differentiated from one another.

2. The carbon nanoparticles as recited in claim 1, wherein the fibers or tubes have a diameter of 1 nm to 500 nm, preferably 10 nm to 100 nm, and more preferably 10 nm to 50 nm.

3. The carbon nanoparticles as recited in claim 1, wherein the secondary agglomerates have a diameter of 500 nm to 1000 μm.

4. The carbon nanoparticles as recited in claim 1, wherein the fibers are of the herringbone type.

5. The carbon nanoparticles as recited in claim 1, wherein the fibers are of the screw type.

6. The carbon nanoparticles as recited in claim 1, wherein the fibers are platelet type.

7. The carbon nanoparticles as recited in claim 1, wherein the tubes are of the single-walled type.

8. The carbon nanoparticles as recited in claim 1, wherein the tubes are of the multiple-walled type.

9. The carbon nanoparticles as recited in claim 1, wherein the tubes are of the loop type.

10. The carbon nanoparticles as recited in claim 1, wherein the secondary agglomerates include combinations of fibers and/or tubes of the different types: herringbone, screw, platelet, single-walled, multiple-walled, and loop.

11. The carbon nanoparticles as recited in claim 1, wherein the circumference Up of the nanoparticles in the two-dimensional projection and the circumference of a circle of the same area Uk are in a ratio of Uk:Up in the range from 1.0 to 0.65.

12. The carbon nanoparticles as recited in claim 1 that can be obtained by means of a CVD process through the use of nanoporous catalyst particles with a spherical and/or spheroidal secondary structure, which contain, as catalytically active components, nanoparticulate metals and/or metal oxides or their precursors.

13. A method for manufacturing the carbon nanoparticles as recited in claim 1 by means of a CVD method using nanoporous catalyst particles with a spherical and/or spheroidal secondary structure, which contain as catalytically active components, nanoparticulate metals and/or metal oxides or their precursors.

14. A use of the carbon nanoparticles recited in claim 1 as adsorbents.

15. A use of the carbon nanoparticles recited in claim 1 as additives or active materials in energy storage systems.

16. A use of the carbon nanoparticles recited in claim 1 as super condensers.

17. A use of the carbon nanoparticles recited in claim 1 as filter media.

18. A use of the carbon nanoparticles recited in claim 1 as catalysts or substrates for catalysts.

19. A use of the carbon nanoparticles recited in claim 1 as sensors or substrates for sensors.

20. A use of the carbon nanoparticles recited in claim 1 as additives for polymers, ceramics, metals and metal alloys, glasses, textiles, and composite materials.
